(19) United States
(12) Patent Application Publication
(10) Pub. No.: US 2006/0196179 A1
(43) Pub. Date: Sep. 7, 2006

(54) Load-sensing integrated brake and fan hydraulic system

(76) Inventors: Arun Kesavan, Plainfield, IL (US); Edward W. Mate, Manhattan, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/067,751

(22) Filed: Mar. 1, 2005

(51) Int. Cl. F16D 31/02

(52) U.S. Cl. 60/413

(57) ABSTRACT

A hydraulic system for a work machine having a power source is disclosed. The hydraulic system has a tank configured to hold a supply of fluid and a source configured to pressurize the fluid. The hydraulic system also has a brake mechanism in fluid communication with the source to receive pressurized fluid and a power source cooling fan in fluid communication with the source to receive pressurized fluid. The hydraulic system further has a load-sensing valve in fluid communication with the source to control an output of the source in response to a load on the brake mechanism and a load on the power source cooling fan.

### TECHNICAL FIELD

The present disclosure relates generally to an integrated brake and fan hydraulic system and, more particularly, to an integrated brake and fan hydraulic system having load-sensing capabilities.

### BACKGROUND

Work machines such as motor graders, wheel loaders, backhoes, excavators, and other work machines often include multiple separate hydraulic systems. For example, a work machine may include a hydraulic system configured to provide pressurized fluid to one or more brake mechanisms that decelerate the work machine. The work machine may also include a cooling system having a hydraulically-driven fan that cools a power source of the work machine. Each of these separate systems may include a fluid pressurizing pump that derives power from the work machine power source and generates an associated efficiency loss for the power source.

In order to minimize the efficiency loss of the power source and overall cost of the work machine, the separate systems may be integrated to receive pressurized fluid from a single common pump. One such system is described in U.S. Pat. No. 6,681,568 (the '568 patent) issued to Smith on Jan. 27, 2004.

The '568 patent describes a fluid system having a common source of pressurized fluid. The pressurized fluid is provided to a first circuit to drive a fluid motor connected to a cooling fan. The pressurized fluid is also provided to a second circuit to charge a brake actuating cylinder. The pressure of the fluid supplied to the first and second circuits is controlled by multiple pressure relief valves.

Although the fluid system of the '568 patent may lower the efficiency losses of the work machine by providing a single pump that is common to the two separate fluid circuits, the pump of the '568 patent could be operated more efficiently. Specifically, because the output of the pump is not controlled according to system load, there may be situations where the output of the pump exceeds system demand. In these situations, the efficiency losses associated with the fluid system of the '568 patent may increase.

The disclosed hydraulic system is directed to overcoming one or more of the problems set forth above.

### SUMMARY OF THE INVENTION

In one aspect, the present disclosure is directed to a hydraulic system for a work machine having a power source. The hydraulic system includes a tank configured to hold a supply of fluid and a source configured to pressurize the fluid. The hydraulic system also includes a brake mechanism in fluid communication with the source to receive pressurized fluid, and a power source cooling fan in fluid communication with the source to receive pressurized fluid. The hydraulic system further includes a load-sensing valve in fluid communication with the source to control an output of the source in response to a load on the brake mechanism and a load on the power source cooling fan.

In another aspect, the present disclosure is directed to a method of operating a hydraulic system. The method includes directing pressurized fluid from a source to a brake mechanism and directing pressurized fluid from the source to a power source cooling fan. The method further includes directing pressurized fluid indicative of a load on the brake mechanism and pressurized fluid indicative of a load on the power source cooling fan through a load-sensing valve back to the source to control an output of the source.

### BRIEF DESCRIPTION OF THE DRAWINGS

FIG. 1 is a diagrammatic illustration of an exemplary disclosed work machine;

FIG. 2 is a schematic illustration of an exemplary disclosed hydraulic system for the work machine of FIG. 1; and

FIG. 3 is a schematic illustration of another exemplary disclosed hydraulic system for the work machine of FIG. 1.

### DETAILED DESCRIPTION

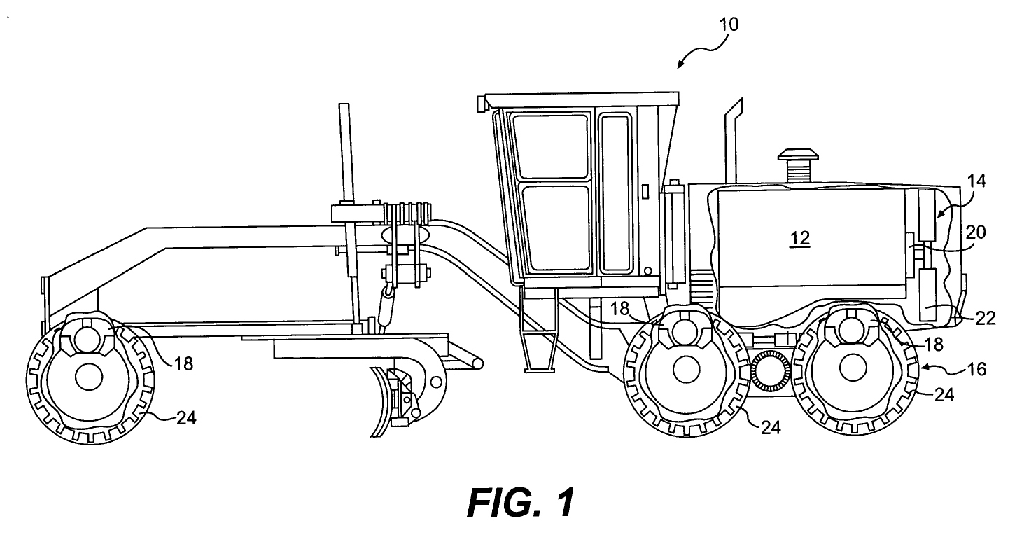

FIG. 1 illustrates an exemplary work machine 10. Work machine 10 may be a fixed or mobile machine that performs some type of operation associated with an industry such as mining, construction, farming, transportation, or any other industry known in the art. For example, work machine 10 may be a motor grader, a wheel loader, a backhoe, an excavator, a passenger vehicle, or any other work machine known in the art. Work machine 10 may include a power source 12 having a cooling fan 14, at least one driven traction device 16, and at least one brake mechanism 18.

Power source 12 may embody an engine such as, for example, a diesel engine, a gasoline engine, a gaseous fuel-powered engine such as a natural gas engine, or any other engine apparent to one skilled in the art. Power source 12 may also embody another source of power such as a fuel cell, a power storage device, or any other suitable source of power.

Cooling fan 14 may be indirectly driven by power source 12. In particular, cooling fan 14 may include a hydraulic motor 20 mounted to power source 12 or work machine 10, and fan blades 22 fixedly connected to hydraulic motor 20. Hydraulic motor 20 may be driven with fluid pressurized by power source 12 to cause fan blades 22 to draw or push air across power source 12 or across a heat exchanger (not shown) associated with power source 12. The flow rate of pressurized fluid through hydraulic motor 20 may correspond to a rotational speed of cooling fan 14.

Driven traction device 16 may include wheels 24 located on each side of work machine 10 (only one side shown). Alternately, driven traction device 16 may include tracks, belts or other driven traction devices. Driven traction device 16 may or may not be steerable.

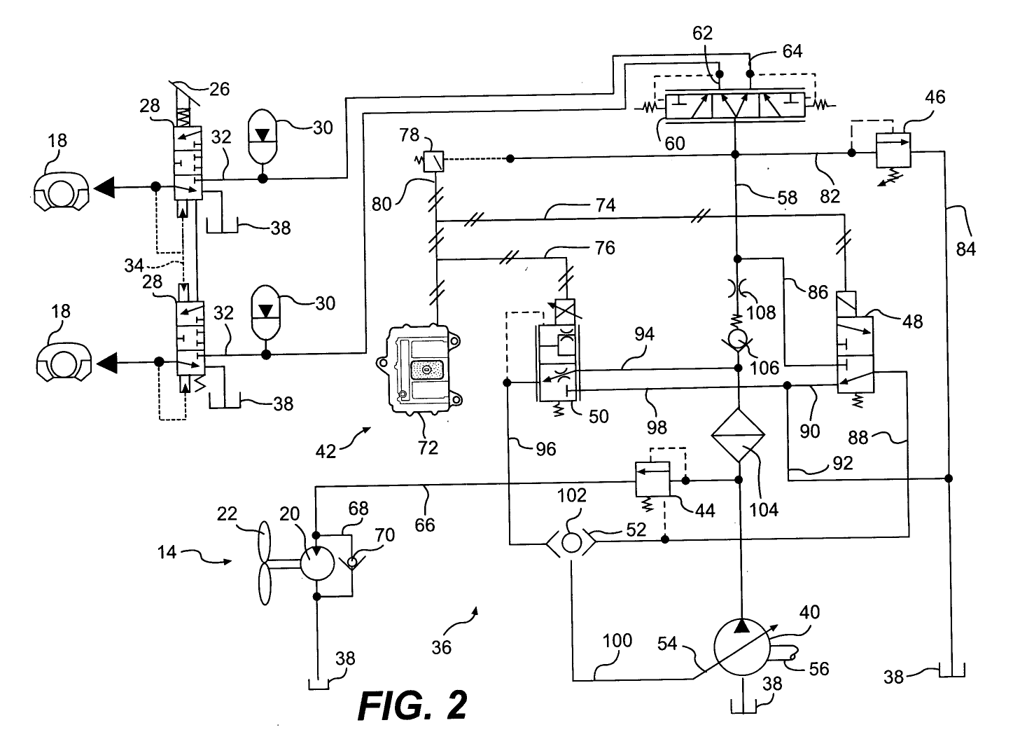

Brake mechanism 18 may be configured to retard the motion of work machine 10 and may be operably associated with each wheel 24 of work machine 10. In one embodiment, brake mechanism 18 may include a hydraulic pressure-actuated wheel brake such as, for example, a disk brake or a drum brake that is disposed intermediate wheel 24 and a drive assembly (not shown) of work machine 10. As illustrated in FIG. 2, brake mechanism 18 may be manually operated using a brake pedal 26, which in turn directs pressurized fluid to brake mechanism 18. A degree of brake pedal actuation may proportionally control a pressure of the fluid supplied to brake mechanism 18.

A brake actuating valve 28 and accumulator 30 may be associated with each brake mechanism 18. Specifically, each accumulator 30 may be fluidly connected to an associated brake mechanism 18 by way of a fluid passageway 32. Accumulator 30 may be configured to hold a supply of pressurized fluid in anticipation of brake actuation. Brake actuating valve 28 may be disposed within fluid passageway 32 and selectively mechanically actuated in response to operator movement of brake pedal 26 to either direct pressurized fluid from accumulator 30 to brake mechanism 18 causing deceleration of work machine 10, or to drain the pressurized fluid from brake mechanism 18 stopping the deceleration of work machine 10. Brake actuating valves 28 associated with separate wheels 24 may be simultaneously operated against a spring bias by way of a common pilot passageway 34.

Work machine 10 may also include a hydraulic system 36 configured to provide pressurized fluid to cooling fan 14 and brake mechanism 18. Specifically, hydraulic system 36 may include a tank 38, a source 40 of pressurized fluid, a control system 42, a priority valve 44, a pressure relief valve 46, a brake control valve 48, a fan control valve 50, and a load-sensing valve 52.

Tank 38 may constitute a reservoir configured to hold a supply of fluid. The fluid may include, for example, a dedicated hydraulic oil, an engine lubrication oil, a transmission lubrication oil, or any other fluid known in the art. One or more hydraulic systems within work machine 10 may draw fluid from and return fluid to tank 38. It is also contemplated that hydraulic system 36 may alternatively be connected to multiple separate fluid tanks.

Source 40 may be configured to produce a flow of pressurized fluid and may include a variable displacement pump such as a swashplate-type pump wherein an angle of a swashplate 54 corresponds to a displacement of associated pump pistons. Source 40 may alternatively include a variable delivery pump such as a metering sleeve-type pump wherein a position of a metering sleeve (not shown) corresponds to a delivery rate of the pump. Source 40 may be drivably connected to power source 12 of work machine 10 by, for example, a countershaft 56, a belt (not shown), an electrical circuit (not shown), or in any other suitable manner. Alternatively, source 40 may be indirectly connected to power source 12 via a torque converter (not shown), via a gear box (not shown), or in any other manner known in the art.

Pressurized fluid from source 40 may be directed to brake mechanism 18 and cooling fan 14. For example, pressurized fluid may be directed from source 40 through a fluid passageway 58 to brake mechanism 18. When work machine 10 includes multiple brake mechanisms 18, an inverse shuttle valve 60 may be disposed between fluid passageway 58 and brake mechanisms 18 to direct the flow of pressurized fluid from source 40 through one or both of fluid passageways 62, 64 that lead to separate brake mechanisms 18 in response to a pressure of the fluid within fluid passageways 62, 64. Pressurized fluid may be directed from source 40 to hydraulic motor 20 of cooling fan 14 via a fluid passageway 66. A passageway 68 having a check valve 70 may be provided to allow regenerative fluid flow to cooling fan 14 when an inertial load on cooling fan 14 is greater than a fluid power supply. In this manner, it may be possible to prevent generating a vacuum at the inlet of cooling fan 14.

Control system 42 may electrically interconnect various components of hydraulic system 36. In particular, control system 42 may include a controller 72 in communication with brake control valve 48 via a communication line 74 and with fan control valve 50 via a communication line 76. Control system 42 may also include a pressure sensor 78 in communication with controller 72 via a communication line 80.

Controller 72 may embody a single microprocessor or multiple microprocessors that include a means for controlling an operation of hydraulic system 36. Numerous commercially available microprocessors can be configured to perform the functions of controller 72. It should be appreciated that controller 72 could readily embody a general work machine microprocessor capable of controlling numerous work machine functions. Controller 72 may include a memory, a secondary storage device, a processor, and any other components for running an application. Various other circuits may be associated with controller 72 such as power supply circuitry, signal conditioning circuitry, solenoid driver circuitry, and other types of circuitry.

Controller 72 may be configured to control an operation of brake control valve 48 in response to a signal from pressure sensor 78. Specifically, pressure sensor 78 may be configured to sense a pressure of the fluid directed to brake mechanism 18 and to generate a signal indicative of the pressure. Controller 72 may receive this signal and move brake control valve 48 between a first position and a second position in response to the signal.

Controller 72 may be further configured to affect movement of fan control valve 50. In one example, controller 72 may receive one or more input indicative of power source and/or cooling fan operation and move fan control valve 50 between a first and second position in response to the input. The input may include, for example, an power source speed, a power source temperature, a power source fueling parameter, a power source pressure, a cooling fan speed, or any other suitable input.

Priority valve 44 may be configured to give priority in receiving pressurized fluid from source 40 to brake mechanism 18 over cooling fan 14. In particular, priority valve 44 may be disposed within fluid passageway 66 and movable in response to the pressure of the fluid from source 40. If the pressure available from source 40 is less than a predetermined value, priority valve 44 may move to restrict the flow of pressurized fluid to cooling fan 14, thereby providing a greater portion of the available flow from source 40 to brake mechanism 18. However, if the pressure available from source 40 is greater than the predetermined value, priority valve 44 may move to allow unrestricted flow of pressurized fluid to cooling fan 14.

Pressure relief valve 46 may be configured to selectively communicate the pressurized fluid that is directed to brake mechanism 18 with tank 38 in response to a fluid pressure. In one example, pressure relief valve 46 may be in communication with the pressurized fluid from source 40 via a fluid passageway 82 and fluid passageway 58, and with tank 38 via a fluid passageway 84. Pressure relief valve 46 may have a valve element that is spring biased toward a valve closing position and movable toward a valve opening position in response to a pressure within fluid passageway 82 being above a predetermined pressure. In this manner, pressure relief valve 46 may be configured to reduce a pressure spike within hydraulic system 36 by allowing fluid having excessive pressures to drain to tank 38. It is contemplated that the predetermined pressure may be varied electronically, manually, or in any other appropriate manner to produce variable pressure relief settings.

Brake control valve 48 may be configured to either communicate the pressurized fluid that is directed to brake mechanism 18 with load-sensing valve 52, or to communicate tank 38 with load-sensing valve 52. Specifically, brake control valve 48 may be in communication with the pressurized fluid that is directed to brake mechanism 18 via a fluid passageway 86, with load-sensing valve 52 via a fluid passageway 88, and with tank 38 via fluid passageways 90 and 92. The fluid within passageway 88 is also in communication with priority valve 44. The pressure of the fluid within fluid passageway 86 may be indicative of a load on brake control valve 48. Brake control valve 48 may include a proportional valve element that is solenoid actuated against a spring bias in response to a signal from controller 72 to move between the first and second positions. When in the first position, the fluid within fluid passageway 86 may flow through fluid passageways 86 and 88 to load-sensing valve 52. When in the second position, load-sensing valve 52 may be communicated with tank 38 via fluid passageways 88, 90, and 92.

Fan control valve 50 may be configured to redirect either a first portion of the pressurized fluid from fluid passageway 58 with load-sensing valve 52, or to redirect an amount less than the first portion to load-sensing valve 52 and to direct the remaining amount of the first portion to tank 38. In particular, fan control valve 50 may be in communication with fluid passageway 58 via a fluid passageway 94, in communication with load-sensing valve 52 via a fluid passageway 96, and with tank 38 via a fluid passageway 98 and fluid passageways 90 and 92. The pressure of the fluid within fluid passageway 96 may be indicative of a load on cooling fan 14. Fan control valve 50 may include a proportional valve element that is solenoid actuated in conjunction with fluid pressure from within fluid passageway 96 against a spring bias in response to a signal from controller 72 to move between the first and second positions. When in the first position, the first portion of fluid from within fluid passageway 94 may be redirected through fluid passageways 94 and 96 to load-sensing valve 52. When in the second position, only part of the first portion may be redirected to load-sensing valve 52 while the remaining part may be directed to tank 38 via fluid passageways 98, 90, and 92.

Load-sensing valve 52 may be configured to selectively allow either the load on brake mechanism 18 or the load on cooling fan 14 to control operation of source 40. In one example, load-sensing valve 52 may be in communication with source 40 via a load-sensing passageway 100. Load-sensing valve 52 may include a shuttle valve element 102 movable by fluid pressure between a first position at which the pressurized fluid indicative of the load on brake mechanism 18 may be directed through fluid passageway 88 to load-sensing passageway 100 for controlling movement of swashplate 54, and a second position at which the pressurized fluid indicative of the load on cooling fan 14 may be directed through fluid passageway 94 to load-sensing passageway 100 for controlling movement of swashplate 54. Shuttle valve element 102 may be moved from the first position toward the second position in response to the pressure of the fluid directed through fluid passageway 96 being greater than the pressure directed through fluid passageway 88. Conversely, shuttle valve element 102 may be moved from the second position toward the first position in response to the pressure of the fluid directed through fluid passageway 88 being greater than the pressure directed through fluid passageway 96.

Hydraulic system 36 may include additional components that cooperate to distribute pressurized fluid from source 40 to brake mechanism 18 and cooling fan 14. Specifically, hydraulic system 36 may include a filter 104, a check valve 106, and a restricted orifice 108 disposed within fluid passageway 58 between source 40 and brake mechanism 18. It is contemplated that hydraulic system 36 may include additional and/or different components such as, for example, makeup valves, pressure-balancing passageways, and other components known in the art.

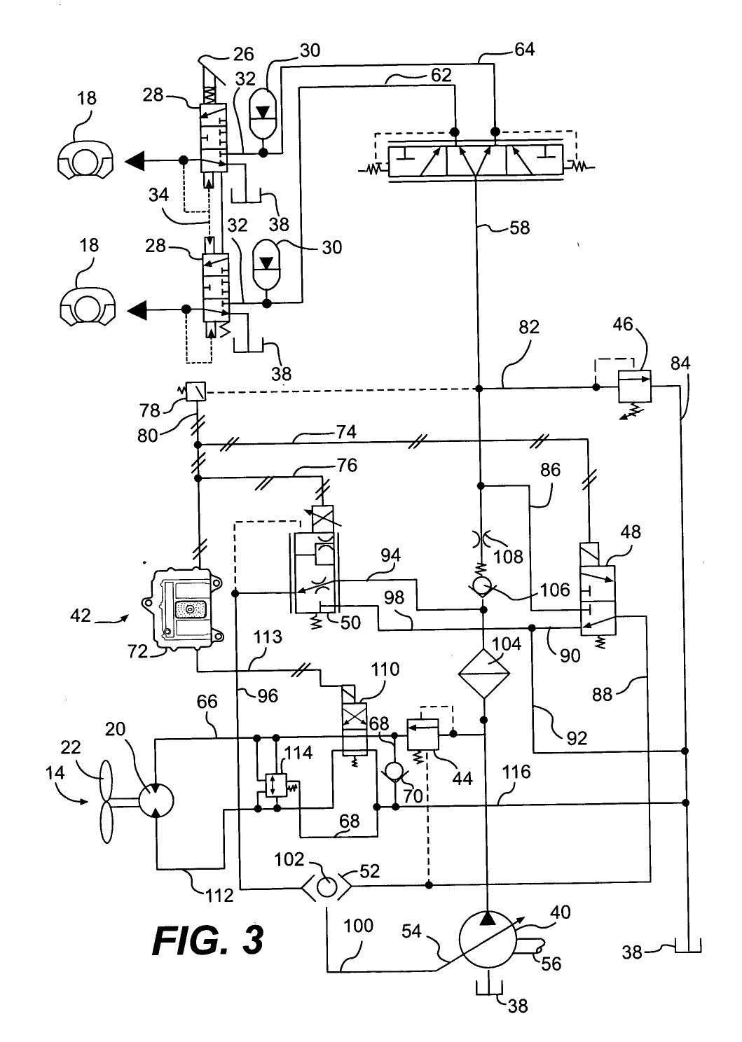

FIG. 3 illustrates another embodiment of hydraulic system 36. Similar to the embodiment of FIG. 2, hydraulic system 36 of FIG. 3 includes tank 38, source 40, brake control valve 48, and fan control valve 50. However, hydraulic system 36 of FIG. 3 also includes a reversing circuit allowing cooling fan 14 to operate in an air pushing direction and an air drawing direction. Specifically, hydraulic system 36 of FIG. 3 may include a reversing valve 110 fluidly connected between fluid passageway 66 and a fluid passageway 112 that leads to tank 38. Reversing valve 110 may include a proportional valve element that is solenoid actuated against a spring bias to move between a first position at which the pressurized fluid directed through fluid passageway 66 drives hydraulic motor 20 of cooling fan 14 in an air pushing direction, and a second position at which the pressurized fluid directed through fluid passageway 112 drives hydraulic motor 20 in an air drawing direction. When one of fluid passageway 66 and 112 are directing pressurized fluid from source 40 to motor 20, the other of fluid passageways 68 and 112 may be simultaneously draining fluid from motor 20 to tank 38 via a fluid passageway 116. Controller 72 may be in communication with reversing valve 110 via a communication line 113 to move the valve element of reversing valve 110 between the first and second positions.

In contrast to hydraulic system 36 illustrated in FIG. 2, hydraulic system 36 of FIG. 3 includes a bypass valve 114. Bypass valve 114 may be movable in response to fluid pressure entering and exiting hydraulic motor 20 exceeding a predetermined pressure. Bypass valve 114 may be movable against a spring bias from a first position at which pressurized fluid flows through hydraulic motor 20 toward a second position at which the pressurized fluid bypasses hydraulic motor 20 and flows directly to tank 38 to prevent excessive pressures from flowing through hydraulic motor 20.

### INDUSTRIAL APPLICABILITY

The disclosed hydraulic system finds potential application in any machine where it is desirable to join a hydraulic brake circuit and a hydraulically-driven cooling fan circuit to utilize a single common pump. The disclosed hydraulic system improves efficiency of a power source driving the single common pump by controlling an output of the pump according to load on both the brake circuit and the cooling fan circuit. Operation of hydraulic system 36 will now be described.

As source 40 pressurizes fluid supplied by tank 38, the pressurized fluid may be directed through fluid passageway 58, inverse shuttle valve 60, through one or both of fluid passageways 62 and 64 to brake mechanism 18, and through fluid passageway 66 to cooling fan 14. If the pressure of the fluid from source 40 falls below a predetermined value, priority valve 44 may move to restrict fluid flow to cooling fan 14, thereby providing a greater portion of the flow from source 40 to brake mechanism 18.

Loading of cooling fan 14 and brake mechanism 18 may control the output of source 40. Pressurized fluid that is indicative of the loads on cooling fan 14 and brake mechanism 18 may be redirected back to swashplate 54 of source 40 via fluid passageways 96 and 88, respectively. Shuttle valve element 102 may resolve the two flows of pressurized fluid and allow the flow having the greater pressure to control the angle of swashplate 54 and thus the output of source 40. If controller 72 detects a pressure within fluid passageway 58 via pressure sensor 78 that is above a predetermined pressure, controller 72 may move the valve element of brake control valve 48 toward the second position, allowing the load on cooling fan 14 to control output of source 40. Conversely, if controller 72 detects a pressure within fluid passageway 58 that is below the predetennined value, controller 72 may move the valve element of brake control valve 48 toward the first position. While the valve element of brake control valve 48 is in the first position, if the pressure within fluid passageway 58 is less than the pressure within fluid passageway 96, the load on cooling fan 14 will continue to control the output of source 40. Otherwise, the load on brake mechanism 18 will control the output of source 40.

Fan control valve 50 may be used to control a speed of cooling fan 14. In particular, the valve element of fan control valve 50 may be moved toward the first position to slow a speed of cooling fan 14 by lowering an output of source 40. The output of source 40 may be lowered by connecting a high pressure fluid with swashplate 54. Conversely, the valve element of fan control valve 50 may be moved toward the second position to increase a speed of cooling fan 14 by increasing an output of source 40. The output of source 40 may be increased by lowering the pressure of the fluid that is in contact with swashplate 54. The pressure may be lowered when the valve element of fan control valve 50 is moved toward the second position, because a portion of the fluid flowing through fluid passageway 94 is allowed to flow to tank 38 via fluid passageway 98 instead of through load-sensing valve 52 to swashplate 54.

It will be apparent to those skilled in the art that various modifications and variations can be made to the hydraulic system of the present disclosure. Other embodiments of the hydraulic system will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A hydraulic system for a machine having a power source, comprising:
a tank configured to hold a supply of fluid;
a source configured to pressurize the fluid;
a brake mechanism in fluid communication with the source to receive pressurized fluid;
a power source cooling fan in fluid communication with the source to receive pressurized fluid; and
a load-sensing valve in fluid communication with the source and configured to control an output of the source in response to a load on the brake mechanism and a load on the power source cooling fan.

2. The hydraulic system of claim 1, further including a priority valve configured to give priority in receiving pressurized fluid to the brake mechanism.

3. The hydraulic system of claim 1, wherein the brake mechanism includes at least one control valve and at least one accumulator in communication with the at least one control valve.

4. The hydraulic system of claim 1, wherein the load-sensing valve includes a valve element in communication with pressurized fluid that is indicative of a load on the brake mechanism and with pressurized fluid that is indicative of a load on the cooling fan, wherein the load-sensing valve is movable to allow the one of the pressurized fluids indicative of the loads on the brake mechanism and the cooling fan having the higher pressure to control the output of the source.

5. The hydraulic system of claim 4, further including a brake control valve having a valve element movable between a first position at which pressurized fluid indicative of the load on the brake mechanism is fluidly communicated with the load-sensing valve, and a second position at which the tank is fluidly communicated with the load-sensing valve.

6. The hydraulic system of claim 5, further including:
a sensor configured to sense a pressure of the fluid received by the brake mechanism and to generate a signal indicative of the pressure; and
a controller in communication with the sensor and the brake control valve, the controller being configured to move the valve element of the brake control valve in response to the signal.

7. The hydraulic system of claim 6, further including a fan control valve having a valve element in communication with the controller and the load-sensing valve, the valve element of the fan control valve being movable to control a speed of the power source cooling fan.

8. The hydraulic system of claim 7, wherein the fan control valve is in selective communication with the tank.

9. The hydraulic system of claim 5, wherein the brake and fan control valves are solenoid actuated.

10. The hydraulic system of claim 1, further including a pressure relief valve in fluid communication with the source.

11. The hydraulic system of claim 1, wherein the pressure relief valve has variable relief settings.

12. A method of operating a hydraulic system, comprising:
directing pressurized fluid from a source to a brake mechanism;
directing pressurized fluid from the source to a power source cooling fan; and
directing pressurized fluid that is indicative of a load on the brake mechanism and pressurized fluid that is indicative of a load on the power source cooling fan through a load-sensing valve to the source to control an output of the source.

13. The method of claim 12, wherein the one of the pressurized fluids indicative of the loads on the brake mechanism and the cooling fan having the higher pressure is allowed to flow through the load-sensing valve to control the output of the source.

14. The method of claim 13, further including:
sensing a pressure of the pressurized fluid directed to the brake mechanism;
generating a signal indicative of the pressure; and
selectively communicating the load-sensing valve with a tank in response to the signal.

15. The method of claim 13, further including selectively communicating the pressurized fluid indicative of a load on the cooling fan with a tank to control a speed of the power source cooling fan.

16. The method of claim 12, further including directing the pressurized fluid first to the brake mechanism and then to the power source cooling fan when the output of the pump is insufficient to meet the demands of both the brake mechanism and the power source cooling fan.

17. The method of claim 12, wherein directing pressurized fluid to a brake mechanism includes directing the pressurized fluid to an accumulator associated with a brake control valve.

18. A work machine, comprising:
a power source configured to produce a power output;
at least one traction device drivably connected to the power source;
a fan configured to cool the power source;
a brake mechanism associated with the at least one traction device and configured to decelerate the work machine; and
a hydraulic system interconnecting the cooling fan and the brake mechanism, the hydraulic system including:
a tank configured to hold a supply of fluid;
a source configured to pressurize the fluid and direct the pressurized fluid to the fan and brake mechanism;
a load-sensing valve in fluid communication with the source and configured to control an output of the source in response to a load on the brake mechanism and a load on the power source cooling fan; and
a priority valve configured to give priority in receiving pressurized fluid to the brake mechanism.

19. The work machine of claim 18, wherein the brake mechanism includes at least one control valve and at least one accumulator in communication with the at least one control valve.

20. The work machine of claim 18, wherein the load-sensing valve includes a valve element in communication with pressurized fluid that is indicative of a load on the brake mechanism and with pressurized fluid that is indicative of a load on the cooling fan, wherein the load-sensing valve is movable to allow the one of the pressurized fluids indicative of the loads on the brake mechanism and the cooling fan having the higher pressure to control the output of the source.

21. The work machine of claim 20, further including:
a brake control valve having a valve element movable between a first position at which pressurized fluid indicative of the load on the brake mechanism is fluidly communicated with the load-sensing valve, and a second position at which the tank is fluidly communicated with the load-sensing valve;
a sensor configured to sense a pressure of the fluid received by the brake mechanism and to generate a signal indicative of the pressure; and
a controller in communication with the sensor and the brake control valve, the controller being configured to move the valve element of the brake control valve in response to the signal; and
a fan control valve having a valve element in communication with the controller and the load-sensing valve, the valve element of the fan control valve being movable to control a speed of the power source cooling fan.

22. The work machine of claim 20, wherein the fan control valve is in selective communication with the tank.

23. The work machine of claim 18, further including a pressure relief valve in fluid communication with the source, wherein the pressure relief valve has variable relief settings.
